(19) United States
(12) Patent Application Publication
(10) Pub. No.: US 2020/0342870 A1
(43) Pub. Date: Oct. 29, 2020

(54) INFORMATION PROCESSING DEVICE AND INFORMATION PROCESSING METHOD

(71) Applicant: SONY CORPORATION, TOKYO (JP)

(72) Inventors: MARI SAITO, KANAGAWA (JP); RITSUKO KANO, TOKYO (JP)

(21) Appl. No.: 16/765,378

(22) PCT Filed: Nov. 14, 2018
(86) PCT No.: PCT/JP2018/042057

§ 371 Date: May 19, 2020

(30) Foreign Application Priority Data
Nov. 28, 2017 (JP) 2017-227376

(51) Int. Cl. G10L 15/22

(52) U.S. Cl. CPC G10L 15/22; G06F 3/167

(57) ABSTRACT

The present technology relates to an information processing device and an information processing method for enabling presentation of a more appropriate utterance guide to a user. An information processing device is provided, which includes a first control unit that controls presentation of an utterance guide suitable for a user who makes an utterance on the basis of user information regarding the user. Therefore, a more appropriate utterance guide can be presented to the user. The present technology can be applied to, for example, a voice interaction system.

### TECHNICAL FIELD

The present technology relates to an information processing device and an information processing method, and more particularly to an information processing device and an information processing method for enabling presentation of a more appropriate utterance guide to a user.

### BACKGROUND ART

In recent years, voice interaction systems that respond to users' utterances have begun to be used in various fields. A voice interaction system is required not only to recognize a voice of a user's utterance but also to estimate an intention of the user's utterance, and to make an appropriate response.

Furthermore, as a system that provides a guidance function to a user who is accustomed to and a user who is not accustomed to using a voice input function, a technology of controlling timing to switch an input mode with guide and an input mode without guide on the basis of a proficiency level of a voice input of a user has been proposed (for example, see Patent Document 1).

### CITATION LIST

### Patent Document

Patent Document 1: Japanese Patent Application Laid-Open No. 2012-230191

### SUMMARY OF THE INVENTION

### Problems to be Solved by the Invention

However, in the above-described guidance function disclosed in Patent Document 1, the presence or absence of a guidance is switched on the basis of the proficiency level of a voice input, but a required guidance is different depending on a proficiency level for a device itself by the user.

Therefore, only the presence or absence of a guidance depending on the proficiency level of a voice input and the timing control are not sufficient to reach an original intention of the user or a function potentially desired by the user, and a technology for presenting a more appropriate guidance (utterance guide) has been demanded.

The present technology has been made in view of such a situation, and enables presentation of a more appropriate utterance guide to a user.

### Solutions to Problems

An information processing device according to the first aspect of the present technology is an information processing device including a first control unit configured to control presentation of an utterance guide suitable for a user who makes an utterance on the basis of user information regarding the user.

An information processing method according to the first aspect of the present technology is an information processing method of an information processing device, the information processing method including, by the information processing device, controlling presentation of an utterance guide suitable for a user who makes an utterance on the basis of user information regarding the user.

In the information processing device and the information processing method according to the first aspect of the present technology, presentation of an utterance guide suitable for a user who makes an utterance is controlled on the basis of user information regarding the user.

An information processing device according to the second aspect of the present technology is an information processing device including a first control unit capable of implementing a same function as a function according to a first utterance in a case where the first utterance is made by a user, and configured to control presentation of an utterance guide for proposing a second utterance shorter than the first utterance.

An information processing method according to the second aspect of the present technology is an information processing method of an information processing device, the information processing method including, by the information processing device that is capable of implementing a same function as a function according to a first utterance in a case where the first utterance is made by a user, controlling presentation of an utterance guide for proposing a second utterance shorter than the first utterance.

In the information processing device and the information processing method according to the second aspect of the present technology, presentation of an utterance guide capable of implementing a same function as a function according to a first utterance in a case where the first utterance is made by a user, and the utterance guide for proposing a second utterance shorter than the first utterance is controlled.

The information processing device according to the first or second aspect of the present technology may be an independent device or may be internal blocks constituting one device.

### Effects of the Invention

According to the first and second aspects of the present technology, a more appropriate utterance guide can be presented to a user.

Note that the effects described here are not necessarily limited, and any of effects described in the present disclosure may be exhibited.

### BRIEF DESCRIPTION OF DRAWINGS

FIG. 1 is a block diagram illustrating an example of a configuration of a voice interaction system to which the present technology is applied.

FIG. 2 is a block diagram illustrating an example of a functional configuration of the voice interaction system.

FIG. 3 is a diagram illustrating an example of a main area and a guide area of a display area.

FIG. 4 is a diagram illustrating a first example of the guide area.

FIG. 5 is a diagram illustrating a second example of the guide area.

FIG. 6 is a diagram illustrating a third example of the guide area.

FIG. 7 is a diagram illustrating a fourth example of the guide area.

FIG. 8 is a diagram illustrating a fifth example of the guide area.

FIG. 9 is a diagram illustrating a sixth example of the guide area.

FIG. 10 is a diagram illustrating a seventh example of the guide area.

FIG. 11 is a diagram illustrating an example of a voice input in a case where a user performs a long utterance.

FIG. 12 is a diagram illustrating an eighth example of the guide area.

FIG. 13 is a diagram illustrating a ninth example of the guide area.

FIG. 14 is a flowchart for describing a flow of guide presentation processing.

FIG. 15 is a flowchart for describing a flow of guide presentation processing according to a user state.

FIG. 16 is a flowchart for describing a flow of guide presentation processing according to way of use.

FIG. 17 is a diagram illustrating a specific example of presentation of an utterance guide at the time of an interaction between a user and a system.

FIG. 18 is a diagram illustrating a configuration example of a computer.

### MODE FOR CARRYING OUT THE INVENTION

Hereinafter, embodiments of the present technology will be described with reference to the drawings. Note that the description will be given in the following order.

1. Embodiment of Present Technology

2. Modification

3. Configuration of Computer

<1. Embodiment of Present Technology>

(Configuration Example of Voice Interaction System)

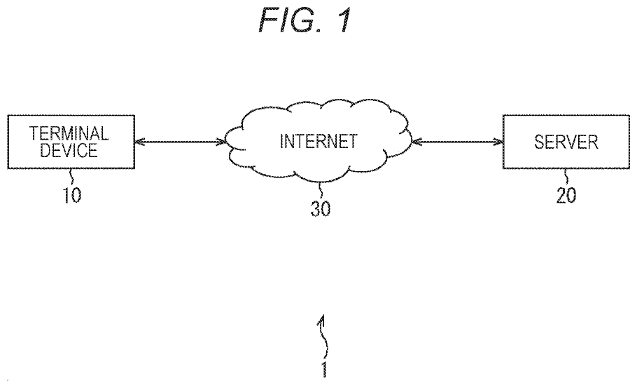

FIG. 1 is a block diagram illustrating an example of a configuration of a voice interaction system to which the present technology is applied.

A voice interaction system 1 includes a terminal device 10 installed on a local side such as a user's home and a server 20 installed on a cloud side such as a data center. In the voice interaction system 1, the terminal device 10 and the server 20 are connected to each other via the Internet 30.

The terminal device 10 is a device connectable to a network such as a home local area network (LAN), and executes processing for implementing a function as a user interface of a voice interaction service.

For example, the terminal device 10 is also called a home agent (agent) or the like, and has functions of voice interaction with a user, playback of music, and voice operation for devices such as a lighting fixture and an air conditioner.

Note that the terminal device 10 is configured as a dedicated terminal, or may be configured as, for example, a mobile device such as a speaker (so-called smart speaker), a game device, or a smartphone, or an electronic device such as a tablet computer or a television receiver.

The terminal device 10 can provide the user with (a user interface of) the voice interaction service by cooperating with the server 20 via the Internet 30.

For example, the terminal device 10 collects a voice (user utterance) emitted by the user, and transmits voice data to the server 20 via the Internet 30. Furthermore, the terminal device 10 receives processed data transmitted from the server 20 via the Internet 30, and presents information such as an image and a voice according to the processed data.

The server 20 is a server that provides a cloud-based voice interaction service, and executes processing for implementing a voice interaction function.

For example, the server 20 executes processing such as voice recognition processing and semantic analysis processing on the basis of the voice data transmitted from the terminal device 10 via the Internet 30, and transmits processed data according to a result of the processing to the terminal device 10 via the Internet 30.

Note that FIG. 1 illustrates a configuration in which one terminal device 10 and one server 20 are provided. However, a plurality of the terminal devices 10 may be provided and data from the terminal devices 10 may be processed by the server 20 in a concentrated manner. Furthermore, for example, one or a plurality of the servers 20 may be provided for each function such as voice recognition or semantic analysis.

(Functional Configuration Example of Voice Interaction System)

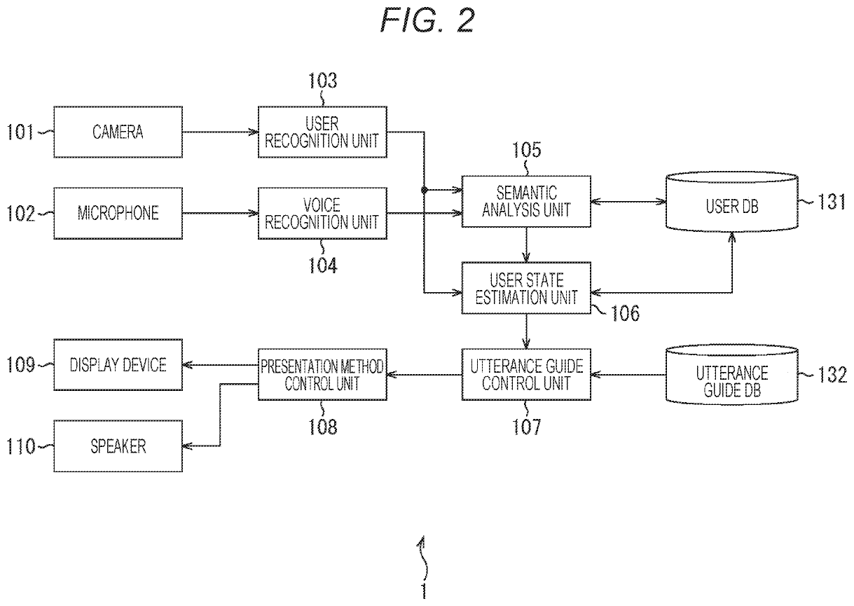

FIG. 2 is a block diagram illustrating an example of a functional configuration of the voice interaction system 1 illustrated in FIG. 1.

In FIG. 2, the voice interaction system 1 includes a camera 101, a microphone 102, a user recognition unit 103, a voice recognition unit 104, a semantic analysis unit 105, a user state estimation unit 106, an utterance guide control unit 107, a presentation method control unit 108, and a display device 109, and a speaker 110. Furthermore, the voice interaction system 1 includes a database such as a user DB 131 and an utterance guide DB 132.

The camera 101 includes an image sensor and supplies image data obtained by imaging an object such as a user to the user recognition unit 103.

The microphone 102 supplies voice data obtained by converting a voice uttered by the user into a voice signal to the voice recognition unit 104.

The user recognition unit 103 executes user recognition processing on the basis of the image data supplied from the camera 101, and supplies a result of user recognition to the semantic analysis unit 105 and the user state estimation unit 106.

In the user recognition processing, the image data is analyzed, and a user around the terminal device 10 is detected (recognized). Furthermore, in the user recognition processing, a direction of the user's line-of-sight, a direction of the face, or the like may be detected using a result of the image analysis.

The voice recognition unit 104 executes voice recognition processing on the basis of the voice data supplied from the microphone 102, and supplies a result of the voice recognition to the semantic analysis unit 105.

In the voice recognition processing, processing of converting the voice data from the microphone 102 into text data is executed by appropriately referring to a database for voice-text conversion or the like, for example.

The semantic analysis unit 105 executes semantic analysis processing on the basis of a result of voice recognition supplied from the voice recognition unit 104, and supplies a result of semantic analysis to the user state estimation unit 106.

In the semantic analysis processing, processing of converting the result of the voice recognition (text data) that is a natural language into an expression understandable by a machine (system) by appropriately referring to a database for voice language understanding or the like is executed, for example. Here, for example, as the result of semantic analysis, a meaning of the utterance is expressed in the form of “intention (Intent)” that the user wants to execute and “entity information (Entity)” that is a parameter of the intention.

Note that, in the semantic analysis processing, the user information recorded in the user DB 131 may be appropriately referred to on the basis of the result of user recognition supplied from the user recognition unit 103, and information regarding a target user may be applied in the result of semantic analysis.

The user state estimation unit 106 executes user state estimation processing by appropriately referring to the user information recorded in the user DB 131 on the basis of information such as the result of user recognition supplied from the user recognition unit 103 and the result of semantic analysis supplied from the semantic analysis unit 105. The user state estimation unit 106 supplies a result of user state estimation obtained in the user state estimation processing to the utterance guide control unit 107.

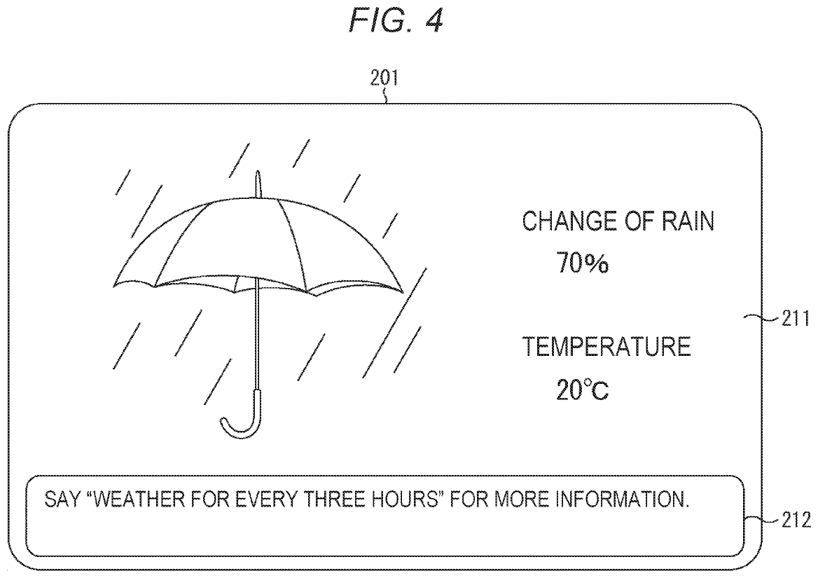

The utterance guide control unit 107 executes utterance guide control processing by appropriately referring to utterance guide information recorded in the utterance guide DB 132 on the basis of the information such as the result of user state estimation supplied from the user state estimation unit 106. The utterance guide control unit 107 controls the presentation method control unit 108 on the basis of a result of execution of the utterance guide control processing. Note that details of the utterance guide control processing will be described below with reference to FIGS. 4 to 13.

The presentation method control unit 108 performs control for presenting an utterance guide to at least one presentation method (output modal) of the display device 109 and the speaker 110 under the control of the utterance guide control unit 107. Note that, here, for the sake of simplicity of description, description mainly focuses on the presentation of an utterance guide. However, for example, information such as content or applications may be presented by the presentation method control unit 108.

The display device 109 displays (presents) information such as an utterance guide under the control of the presentation method control unit 108.

Here, the display device 109 is configured as, for example, a projector, and projects a screen including the information such as an image and a text (for example, an utterance guide and the like) on a wall surface, a floor surface, or the like. Note that the display device 109 may be configured by a display such as a liquid crystal display or an organic EL display.

The speaker 110 outputs (presents) a voice such as an utterance guide under the control of the presentation method control unit 108. Note that the speaker 110 may output music, sound effects (for example, notification sound, feedback on, and the like), and the like in addition to a voice.

The databases such as the user DB 131 and the utterance guide DB 132 are recorded on a recording unit such as a hard disk or a semiconductor memory.

The user DB 131 records user information regarding a user. Here, the user information can include any type of information regarding the user, for example, personal information such as name, age, and gender, use history information of the system functions, applications, and the like, and user state information such as a habit and an utterance tendency at the time of a user's utterance. Furthermore, the utterance guide DB 132 records utterance guide information for presenting an utterance guide.

The voice interaction system 1 is configured as described above.

Note that which of the terminal device 10 (FIG. 1) and the server 20 (FIG. 1) the camera 101 to the speaker 110 are incorporated into is arbitrary in the voice interaction system 1 in FIG. 2. The configuration can be, for example, as follows.

That is, the camera 101, the microphone 102, the display device 109, and the speaker 110, which function as a user interface, are incorporated in the local-side terminal device 10, whereas the user recognition unit 103, the voice recognition unit 104, the semantic analysis unit 105, the user state estimation unit 106, the utterance guide control unit 107, and the presentation method control unit 108, which are the other functions, can be incorporated in the cloud-side server 20.

(Presentation Example of Display Device)

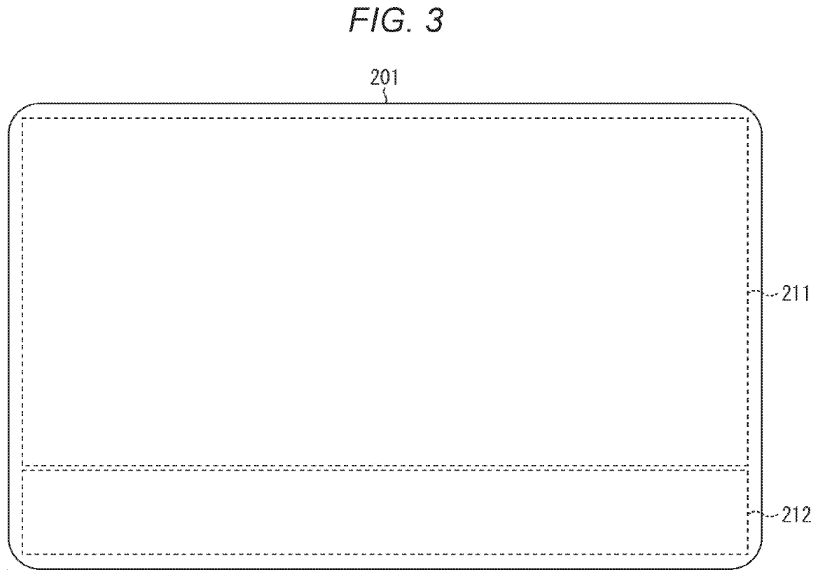

FIG. 3 is a diagram illustrating an example of a display area 201 presented by the display device 109 in FIG. 2.

The display area 201 includes a main area 211 and a guide area 212.

The main area 211 is an area for presenting main information to the user. In the main area 211, for example, information such as a character of an agent and an avatar of the user are presented in addition to content and applications.

Here, the content includes, for example, moving images, still images, map information, weather forecasts, games, books, advertisements, and the like. Furthermore, the applications include, for example, a music player, an instant messenger, a chat such as a text chat, a social networking service (SNS), and the like.

The guide area 212 is an area for presenting an utterance guide to the user. In the guide area 212, various utterance guides suitable for the user who uses the system are presented.

Note that the utterance guide presented in the guide area 212 may or may not work together with the content, application, agent character, or the like presented in the main area 211. In a case where the utterance guide does not work together with the presentation in the main area 211, only the presentation of the guide area 212 can be sequentially switched according to the user who uses the system.

Furthermore, as illustrated in FIG. 3, a ratio of areas between the main area 211 and the guide area 212 in the display area 201 is set basically such that the main area 211 mainly occupies a large area of the display area 201 and the remaining area is the guide area 212. However, how these areas are allocated can be arbitrarily set.

Furthermore, in FIG. 3, the guide area 212 is displayed in a lower area in the display area 201. However, the display area of the guide area 212 can be arbitrarily set to a left area, a right area, or an upper area in the display area 201, for example.

(Utterance Guide Control Processing)

Next, details of the utterance guide control processing executed by the utterance guide control unit 107 will be described.

In the utterance guide control processing, an utterance guide presented by the display device 109 or the speaker 110 is dynamically controlled on the basis of one control method or a combination of a plurality of control methods, of utterance guide control methods (A) to (L) below, for example.

(A) Present an utterance guide including a function proposal

(B) Present an utterance guide while expressing an agent's feeling

(C) Present utterance guides by switching variations one after another

(D) Present an utterance guide according to a proficiency level

(E) Present an utterance guide according to a taste or a behavioral tendency

(F) Present an utterance guide according to an utterance habit or an utterance tendency

(G) Present an utterance guide according to success or failure of recognition

(H) Present a recommendation of a short utterance at the time of achieving a goal with a long utterance

(I) Present an utterance guide according to the degree of relaxation

(J) Present an utterance guide according to a situation

(K) Present an utterance guide according to way of use of an application

(L) Others

Hereinafter, details of the above-described utterance guide control methods (A) to (L) will be sequentially described with reference to FIGS. 4 to 13, and the like.

(A) First Utterance Guide Control Method

In the case of using the above-described first utterance guide control method (A), the function proposal is included in the utterance guide and presented. For example, a scene in which the first interaction is performed as described below is assumed as an interaction between the user and the system. Note that, in the following description, the user's utterance is written as “U (User)”, and the response voice of the voice interaction system 1 is written as “S (System)” in the interaction.

(Example of First Interaction)

U: “Tell me the weather”

S: “Today's weather is rainy”

In the first interaction example, the voice interaction system 1 acquires information of today's weather forecast because the intention of the user utterance of “Tell me the weather” is “weather check” and has made a response of “Today's weather is rainy”.

At this time, in the voice interaction system 1, the utterance guide control unit 107 presents an utterance guide of “Tell me “weather for every three hours” for more information” in the lower guide area 212 in the display area 201, as illustrated in FIG. 4.

As described above, in the first utterance guide control method, the utterance guide is presented in the guide area 212, and the function related to weather is proposed, whereby the user is able to know the new function and can improve the proficiency level for the function. Furthermore, here, the function related to weather has been proposed according to the content of the user's utterance. Therefore, the possibility of an inappropriate proposal is extremely low.

Note that, here, “weather for every three hours” has been proposed. However, for example, other functions related to weather such as “weather for every week” and “weather of another place” may be proposed. Furthermore, the weather check is an example, and other functions according to the user's intention can be proposed, such as check of schedule, news, and traffic information, for example.

(B) Second Utterance Guide Control Method

In the case of using the above-described second utterance guide control method (B), an utterance guide is presented while expressing an agent's feeling. For example, in a case where the user has uttered “xxxxxx”, the voice interaction system 1 can present an utterance guide while expressing an agent's feeling in the guide area 212 when the voice interaction system 1 has not been able to recognize the user's intention.

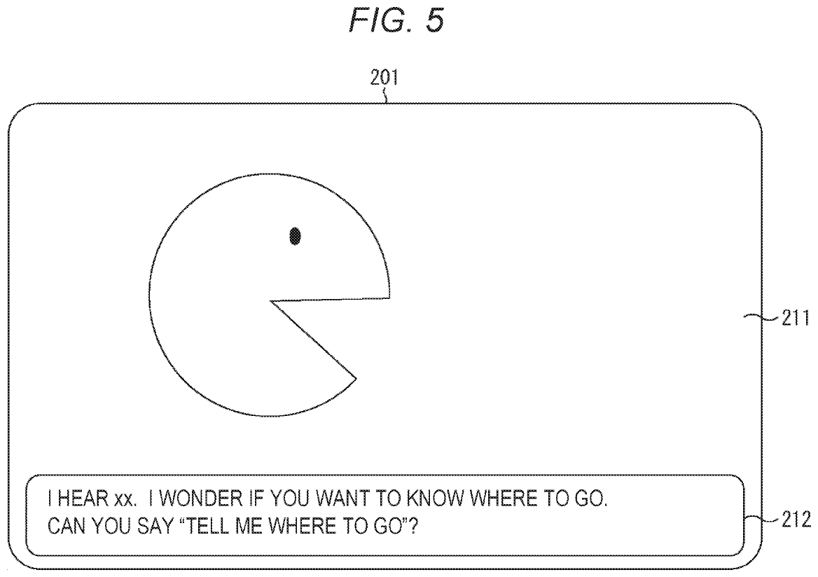

For example, in a case where the voice interaction system 1 has obtained an intention (Intent) of “going out” as a result of semantic analysis although (a score of) reliability is low, the voice interaction system 1 presents an utterance guide of “I hear xx. I wonder if you want to know where to go. Can you say “Tell me where to go”?” as an agent's feeling in the guide area 212, as illustrated in FIG. 5.

As described above, in the second utterance guide control method, even if the reliability of the result of semantic analysis is low, the agent's feeling is expressed like muttering instead of a tone of command to propose an utterance, thereby increasing the possibility that the user makes an utterance according to the agent's instruction, for example. In this case, the possibility that the user checks the utterance guide in the guide area 212 and utters “Tell me where to go” can be increased.

Note that, in a case where the reliability of a result of semantic analysis is low in a conventional voice interaction system, the system returns a response such as “The system cannot recognize it. Please restate it in different words”. or the like. However, the user cannot understand the reason of failure in recognition and furthermore, there is a possibility that the response gives a mechanical impression and loses the user's willingness to perform an interaction.

Furthermore, for example, in a case where the voice interaction system 1 has obtained an intention (Intent) of “music play” as a result of semantic analysis although the reliability is low, the voice interaction system 1 can present an utterance guide of “xxx may be music. May be not. I will recognize it if you say “Play music of xxx”” as the agent's feeling in the guide area 212.

Even in this case, by expressing the agent's feeling like muttering to propose an utterance, the possibility that the user utters “Play music of xxx” can be increased.

Furthermore, here, the mutter may not be integrated with the utterance guide. For example, by writing the user's utterance into text and adding characters (character strings) such as “???” or “ . . . ?”, only inability of interpretation by the system is presented, and then an utterance guide may be presented. In this case, the presentation of inability of interpretation and the presentation of an utterance guide are desirably expressed in a distinguishable manner by the user.

Note that, in FIG. 5, an agent's character is presented in the main area 211 in the display area 201, and an utterance guide may be presented in a speech bubble as if the agent's character was speaking the proposal content of the utterance guide.

Furthermore, here, an example of presenting the agent's character in the main area 211 has been described. However, the agent's character may not be presented (hidden), and another information such as image and text (for example, information related to the user's utterance) may be presented.

(C) Third Utterance Guide Control Method

In the case of using the above-described third utterance guide control method (C), if an utterance guide is selectively presented according to each state, there is a high possibility of missing the content of the utterance guide. Therefore, utterance guides are presented by sequentially switching variations (by switching variations one after another).

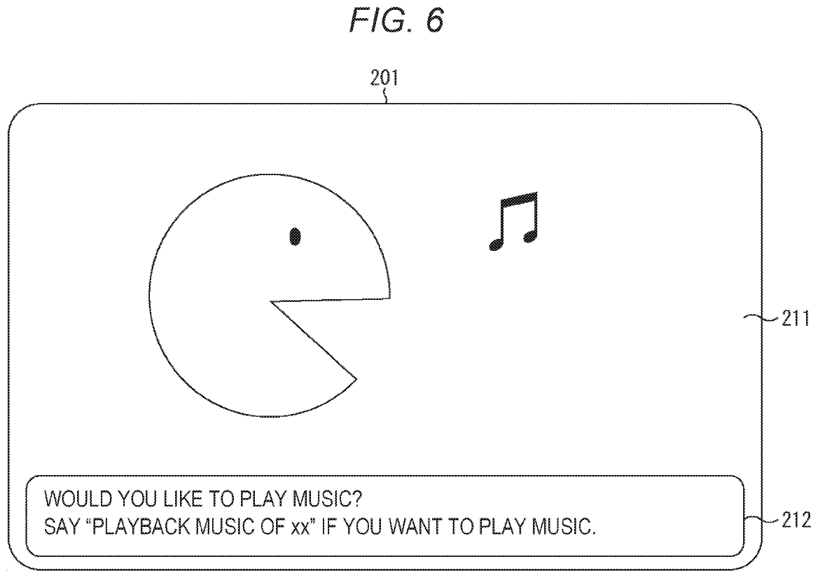

For example, the voice interaction system 1 first presents an utterance guide of “Would you like to play music? Say “Play music of xx” if you want to play music” in the guide area 212, as illustrated in FIG. 6, in a case where the intention (Intent) of “music play” is obtained as a result of semantic analysis although (the score of) reliability is low.

At this time, if the user who has checked the utterance guide utters “Play music of xx”, the voice interaction system 1 can execute a function to play the music of “xx” according to the intention (Intent) of “music play”.

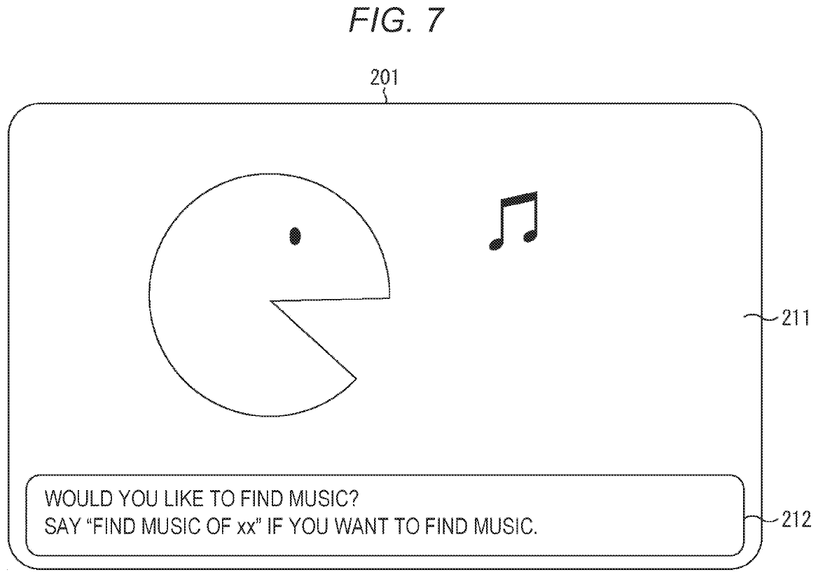

Meanwhile, for example, when the user did not make an utterance and a certain time has elapsed although the utterance guide in FIG. 6 was presented, the voice interaction system 1 presents another utterance guide, as illustrated in FIG. 7. In FIG. 7, an utterance guide of “Would you like to find music? Say “Find music of xx” if you want to find music” is presented in the guide area 212.

Then, if the user who has checked the utterance guide utters “Find music of xx”, the voice interaction system 1 can execute a function to search for the music of “xx” according to the intention (Intent) of “music search”.

Furthermore, although illustration is omitted, when a certain time has elapsed after the utterance guide has been presented, a different utterance guide is then similarly presented in the guide area 212, and the utterance guides can be presented by switching variations one after another.

As described above, in the third utterance guide control method, in a case where functions are nested such as the above-described music function, for example, the functions are grouped, and an utterance guide according to each function can be sequentially presented.

Furthermore, in presenting the utterance guides by switching variations one after another, the utterance guides are presented in order from an utterance guide having a higher possibility of being to be uttered by the user (a higher possibility of being suitable for the user) (for example, an utterance guide having the highest reliability of the result of semantic analysis is presented first), whereby the possibility of presenting a desired utterance guide as the utterance guide can be increased. Moreover, in presenting a next utterance guide after the elapse of a certain time after presenting a certain utterance guide, the utterance guides can be presented in descending order of priority.

Furthermore, for example, the voice interaction system 1 first presents an utterance guide of “Would you like to find a resort? Can you say “Find an amusement park” or the like?” in the guide area 212, for example, in a case where an intention “Intent” of “resort search” is obtained as a result of semantic analysis although the reliability is low.

At this time, if the user who has checked the utterance guide utters “Find an amusement park”, the voice interaction system 1 can execute a function to search for an amusement park according to the intention (Intent) of “amusement park search”.

Meanwhile, thereafter, when a certain time has elapsed, the voice interaction system 1 presents an utterance guide of “Do you want to see favorite resorts? I will show you if you say “Show me resorts I have seen so far” (switches the presentation of the utterance guide) in the guide area 212.

Then, if the user who has checked the utterance guide utters “Show me resorts found so far”, the voice interaction system 1 can execute a function to search for the resorts that the user has seen in the past according to the intention (Intent) of “resort search”.

(D) Fourth Utterance Guide Control Method

In the case of using the above-described fourth utterance guide control method (D), an utterance guide is presented according to the proficiency level of the user.

For example, the voice interaction system 1 presents an utterance guide regarding more basic functions (hereinafter also referred to as a basic guide) in a case where the target user starts using the system, and presents an utterance guide regarding more advanced functions (hereinafter also referred to as an application guide) when the target user becomes familiar with functions at some level, on the basis of the proficiency level of the target user.

That is, for example, when the user starts using the system, the user does not know what kinds of functions are included. Therefore, the voice interaction system 1 presents the basic guide as the utterance guide to be presented in the guide area 212 so that the user can become familiar with the system.

Thereafter, when the proficiency level for each function increases as the user uses the system to some extent, the voice interaction system 1 presents the application guide for the functions with a high proficiency level so that the user becomes able to use higher functions. That is, since there are some functions that some users want to use when the users use the system to some extent, the application guide can present how to use such functions.

Note that the proficiency level can be calculated for each function on the basis of information such as use history information of the target user included in the user information recorded in the user DB 131, for example. However, in a case where the proficiency level for each function is unknown, the utterance guide to be presented can be switched from the basic guide to the application guide when a certain time has elapsed since the start of use of the system by the user or when a certain time has elapsed for the use time for a certain function.

Furthermore, in presenting the basic guide or the application guide, the amount of information to be presented (proposal content) may be increased for a function frequently used by the target user, as compared with a function less frequently used by the target user, by presenting more variations in wording, on the basis of the user information such as use history information. Moreover, here, two stages of utterance guides of the basic function and the application function have been described. However, any utterance guides can be presented as long as there are two stages or more, and an utterance guide of an intermediate function of the two functions may be presented, for example.

(E) Fifth Utterance Guide Control Method

In the case of using the above-described fifth utterance guide control method (E), an utterance guide regarding an area of interest is preferentially presented according to a taste or a behavioral tendency of the user.

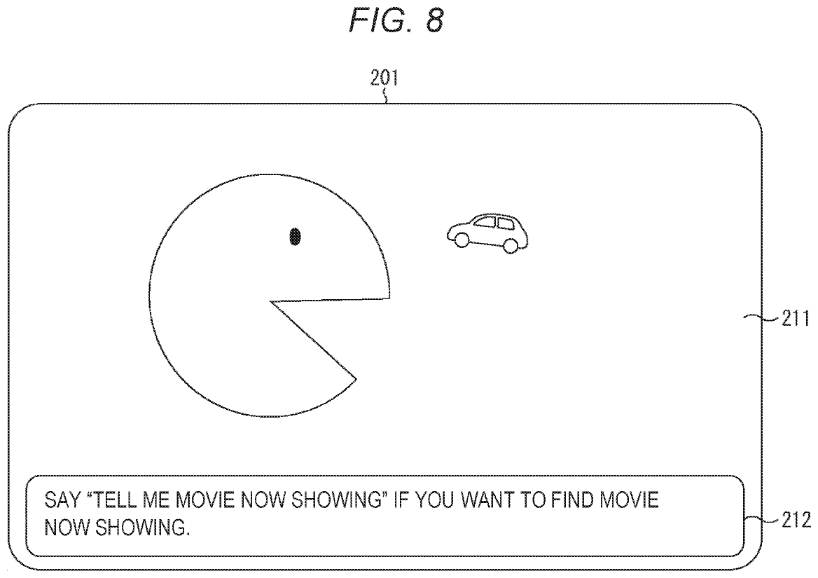

For example, the voice interaction system 1 presents an utterance guide of “Say “Tell me a movie now showing” if you want to find a movie now showing” in the guide area 212, as illustrated in FIG. 8, in a case where the voice interaction system 1 recognizes that the target user is a user who likes to go out and is more interested in movies than meals on the basis of the user information.

As described above, in the fifth utterance guide control method, a more suitable function proposal is made by preferentially presenting the utterance guide regarding a movie to the user who is more interested in movies so that the possibility that the user makes an utterance according to the utterance guide can be increased.

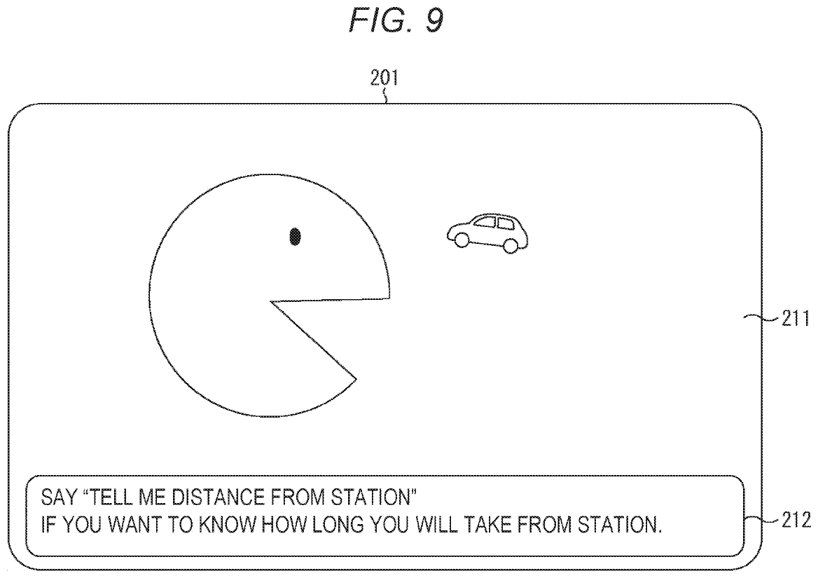

Meanwhile, the voice interaction system 1 presents an utterance guide of “Say “Tell me a distance from the station” if you want to know how long you will take from the station” in the guide area 212, as illustrated in FIG. 9, in a case where the voice interaction system 1 recognizes that the target user is a user who likes to go out and is more interested in meals than movies.

As described above, in the fifth utterance guide control method, even for the users who both like to go out, the content of the utterance guide to be presented in the guide area 212 is changed between the user who is more interested in movies than meals and the user who is more interested in meals than movies, and the utterance guide regarding an area of interest is preferentially presented, whereby a more precise function proposal can be made.

That is, the test (interest) and the behavioral tendency are different depending on the user, and in a case where an utterance guide is uniformly presented to propose a function to each user without considering the difference, the effect is reduced if the utterance guide is inappropriate. In the fifth utterance guide control method, an utterance guide according to the taste and the behavioral tendency of each other is presented. Therefore, a more effective function can be proposed.

Furthermore, for example, in a case where the voice interaction system 1 recognizes that the target user is interested in the latest music scene on the basis of the user information in activating a music player (application) in a device such as the terminal device 10, the voice interaction system 1 presents an utterance guide of “Say “Tell me the latest hit song” if you want to listen to a new song” in the guide area 212.

Meanwhile, for example, in a case where the voice interaction system 1 recognizes that the taste of the target user changes depending on the situation in activating the music player, the voice interaction system 1 presents an utterance guide of “Say “Play quiet music” if you want to choose music by mood” in the guide area 212. Note that, at this time, in a case where the frequency of use of the music player by the target user is high, for example, variation of the mood may be changed and presented.

As described above, the content of the utterance guide to be presented in the guide area 212 is changed between the user who is interested in the latest music scene and the user who's taste changes depending on the situation, and the utterance guide regarding an area of interest is preferentially presented, whereby a more precise function proposal can be made.

(F) Sixth Utterance Guide Control Method

In the case of using the above-described sixth utterance guide control method (F), an utterance guide is presented according to an utterance habit of the user.

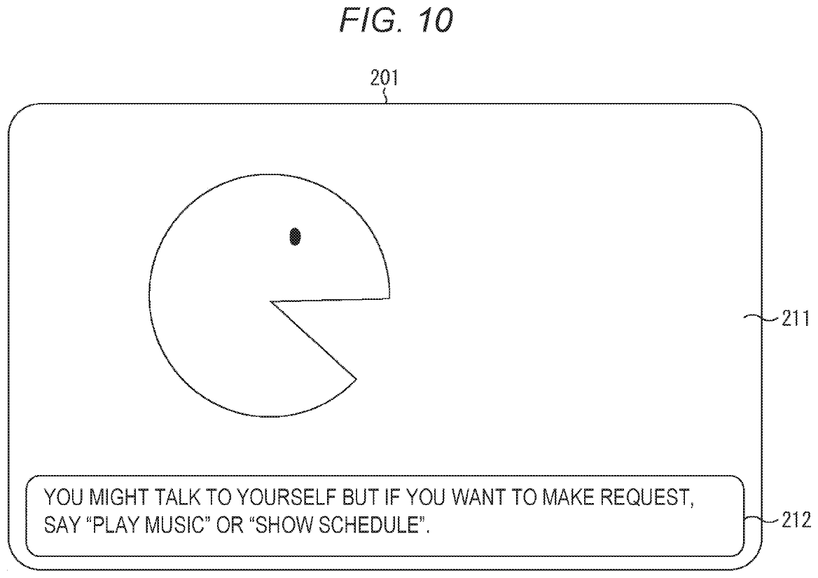

In a case where the voice interaction system 1 recognizes that the target user utters “I want to do xxx” as an utterance habit of the target user on the basis of the user information, for example, the voice interaction system 1 presents an utterance guide of “You might talk to yourself but if you want to make a request, say “Play music” or “Show me schedule”” in the guide area 212, as illustrated in FIG. 10, when such an utterance is made.

As described above, in the sixth utterance guide control method, the utterance guide is switched using the utterance habit of the user, whereby a re-request can be precisely proposed to the user who has made an utterance that is difficult to determine whether it is a request or a non-request.

Furthermore, a scene where some users utter an exclamation word such as “Oh, this”, “Oh, super”, or “hmm” is supposed every time some presentation is made in the display area 201. In such a scene, even if the voice interaction system 1 proposes an utterance guide in the guide area 212 every time an exclamation such as “Oh, this” is uttered, most utterance guides are not suitable function proposals.

Therefore, in the case where an exclamation such as “Oh, this” is uttered, the voice interaction system 1 does not present an utterance guide in the guide area 212 and ignores the utterance such as “Oh, this”. Thereby, unnecessary utterance guide presentation to the user can be suppressed.

Furthermore, the user's utterance habit is not limited to the exclamation such as “Oh, this”. For example, in a case where some presentation is made in the display area 201, a scene where some users utter the content of the presentation (simply read out the presented text instead of making a request to the system) is supposed. At this time, if the voice interaction system 1 takes that the utterance is a request and operates every time such an utterance is made (for example, presents an utterance guide in the guide area 212), the user utters “return” every time.

Therefore, even if such an utterance of presentation content is made, the voice interaction system 1 does not present an utterance guide in the guide area 212 and ignores the utterance.

As described above, in the sixth utterance guide control method, the content of the utterance guide to be presented in the guide area 212 is switched according to the habit or utterance tendency (easy to say) of the user because the user has a habit of saying and an utterance tendency (easy to say), whereby a more suitable function proposal can be made.

Note that the voice interaction system 1 may not present an utterance guide when the user makes an utterance within a certain period. Furthermore, in a case where there is a difference in operation speed depending on the user, the start of utterance guide presentation may be delayed for a user who's operation is long (slow), for example.

(G) Seventh Utterance Guide Control Method

In the case of using the above-described seventh utterance guide control method (G), an utterance guide is presented according to success or failure of recognition of an utterance of the user.

For example, in a case where out of domain (OOD) is obtained as a result of semantic analysis in the semantic analysis processing by the semantic analysis unit 105, which means that the score of reliability is low and the result is not correct, the voice interaction system 1 widely presents functions in the guide area 212. Here, for example, a proposal of functions related to weather and going-out can be presented as the utterance guide in the guide area 212.

As described above, in the seventh utterance guide control method, a wide variety of functions are presented without limiting the function in the case where the reliability of the result of semantic analysis is low, whereby the possibility that the user selects a desired function from among the presented functions can be increased.

Furthermore, for example, in a case where the user' utterance is determined to be a restated utterance on the basis of the result of semantic analysis, the voice interaction system 1 does not present an utterance guide in the guide area 212 and ignores the restated utterance. For example, in a case where the user who has uttered “Tell me the weather” restates the utterance of “Tell me the weather” again, the voice interaction system 1 reacts to only the preceding utterance and does not react to the restated utterance.

As described above, in the seventh utterance guide control method, an utterance guide is not presented to the restated utterance, and the restated utterance is ignored, whereby unnecessary utterance guide presentation (repetitive presentation) to the user can be suppressed.

Note that, in the voice interaction system 1, an utterance guide that has uttered by the user or has been used by the user a plurality of times as a result of being presented may not be presented thereafter. It can be said that the target utterance guide has played a role.

Furthermore, some users are supposed to give an instruction many times in the same manner. The voice interaction system 1 may unconditionally execute the instruction (instruction in the same manner) (or confirm whether or not to execute the instruction) instead of presenting an utterance guide to the user.

Moreover, the voice interaction system 1 may select an utterance that is frequently used by other users who use the system in a similar manner on the basis of the user information of other users recorded in the user DB 131, and present the utterance as an utterance guide.

(H) Eighth Utterance Guide Control Method

In the case of using the above-described eighth utterance guide control method (H), a recommendation of a shorter utterance is presented as an utterance guide when the user has achieved a goal with a long utterance.

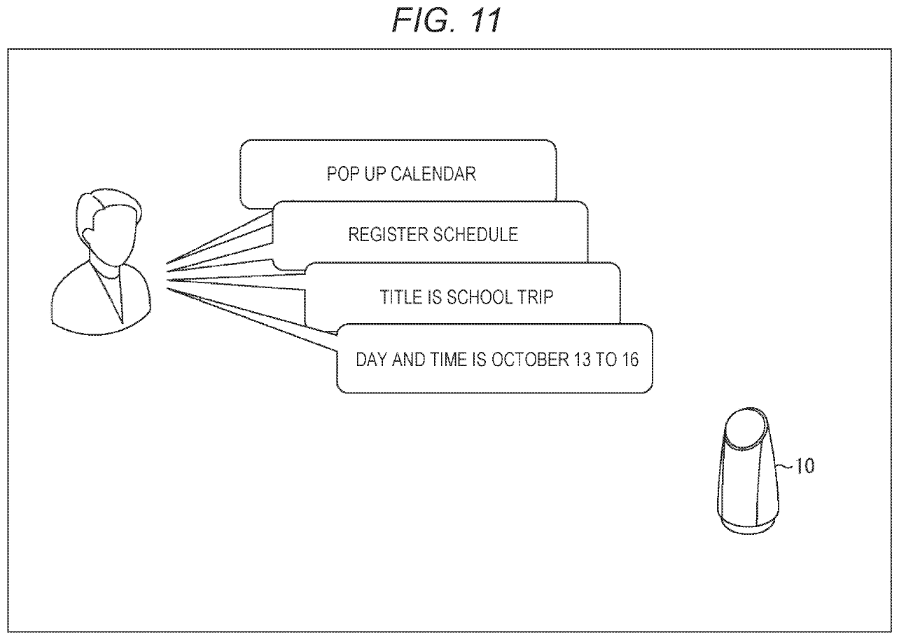

Here, a scene in which the second interaction is performed, as illustrated in FIG. 11, is assumed as an interaction between the user and the system in a case where the user makes a long utterance.

(Example of Second Interaction)

U: “Pop up the calendar”

U: “Register a schedule”

U: “Title is school trip”

U: “Date and time is October 13 to 16”

S: “Schedule of school trip from October 13 to 16 has been registered”.

In this second interaction example, when the user utters “Pop up the calendar”, an application of the calendar is activated and is presented in (the main area 211 in) the display area 201 in the local-side terminal device 10, for example. Furthermore, when the user utters “Register a schedule”, a schedule registration screen is presented in (the main area 211 in) the display area 201.

Then, when the user further utters “Title is school trip” and “Date and time is October 13 to 16”, Intent=“schedule registration” and Entity=“school trip” and “October 13 to October 16” are obtained as a result of semantic analysis obtained from the user's utterance. Therefore, a schedule is registered. For example, a user who is accustomed to a user interface (UI) that follows a menu on a device such as a personal computer or a smartphone tends to perform such a sequential utterance.

In this way, the user has achieved the goal of schedule registration as a result by making a long utterance. However, in practice, the voice interaction system 1 has a function to register a schedule without making such a long utterance. Therefore, in the case where the user has achieved the goal with a long utterance, the voice interaction system 1 presents a recommendation of a shorter utterance as an utterance guide in the guide area 212.

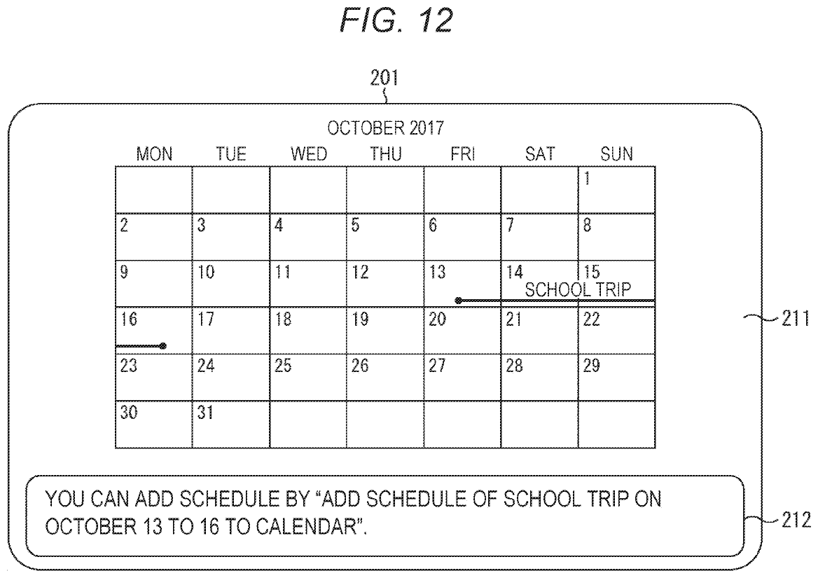

For example, in a case where the voice interaction system 1 recognizes that the target user has registered the schedule with the long utterance illustrated in FIG. 11 on the basis of the user information, the voice interaction system 1 presents an utterance guide of “You can add a schedule by “Add schedule of school trip on October 13 to 16 to calendar” in the guide area 212, as illustrated in FIG. 12.

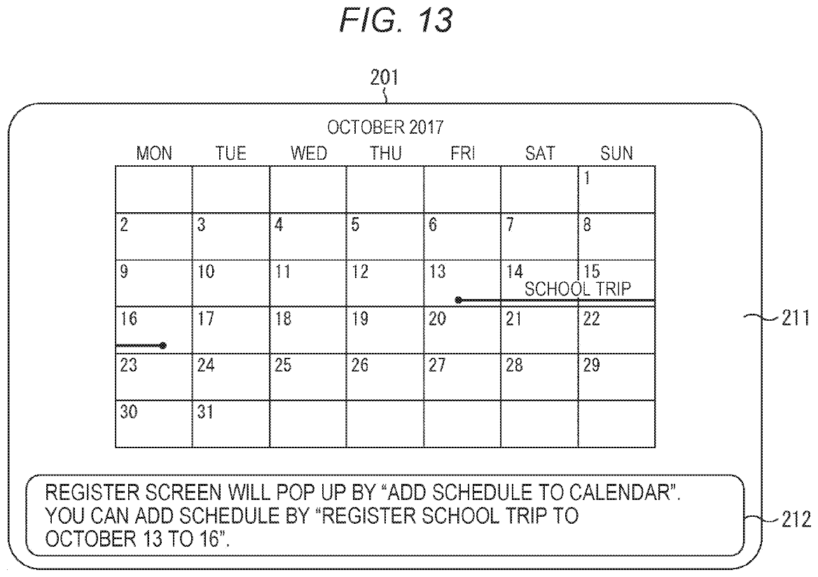

Note that the target user to which such a shortened utterance is recommended can be a user having a considerably high proficiency level For example, for a moderate user who is not so proficient, an utterance guide of “Registration screen will pop up by “Add schedule to calendar”. You can add schedule by “Register school trip to October 13 to 16”” can be presented as illustrated in FIG. 13.

As described above, in the eighth utterance guide control method, a short utterance is recommended as an utterance guide when the user has achieved a goal with a long utterance, whereby the user can register a schedule easily and reliably with a shorter utterance when registering a schedule in the next and subsequent times. Furthermore, in the eight utterance guide control method, the content of the recommended short utterance is changed according to the proficiency level of the user on the basis of the user information, whereby a more suitable function proposal can be made.

(I) Ninth Utterance Guide Control Method

In the case of using the above-described ninth utterance guide control method (I), an utterance guide is presented according to the degree of relaxation of the user.

For example, in a case where the voice interaction system 1 recognizes (estimates) that the target user's mind is relaxed on the basis of a result of user state estimation, the voice interaction system 1 presents more guide information and function proposals as utterance guides to be presented in the guide area 212.

Furthermore, here, for example, when recognizing that the user speaks slowly, there is no movement in a room, the user sits on a sofa, the user focuses on a screen, the face does not look aside, or the like, on the basis of the result of user recognition and the result of voice recognition, the voice interaction system 1 can determine that the user is in a state where the mind is relaxed.

On the other hand, in a case of recognizing that the target user's mind seems not relaxed, the voice interaction system 1 presents less guide information and function proposals as utterance guides to be presented in the guide area 212, for example. For example, here, an utterance guide may not be presented or only information regarding explanation and guidance may be presented as an utterance guide without proposing a function.

Furthermore, here, for example, when recognizing that the user's schedule is busy, the user is watching something while doing something else, the user is using something while moving, or the like, on the basis of the information such as the user information, a result of user recognition, and a result of voice recognition, the voice interaction system 1 can determine that the user is in a state where the mind is not relaxed.

As described above, in the ninth utterance guide control method, the amount of presentation of utterance guides and the amount of proposed function are controlled on the basis of indices representing the user's emotions such as the degrees of relaxation and urgency, whereby a more suitable function proposal can be made.

(J) Tenth Utterance Guide Control Method

In the case of using the above-described tenth utterance guide control method (J), an utterance guide is presented according to the situation of the user.

For example, in a case where the target user is in a place where “doing two things at one time” is more likely to be performed, such as a kitchen, entrance, or lavatory, the voice interaction system 1 performs a guide with the auditory modal by outputting a voice corresponding to an utterance guide from the speaker 110.

That is, in this case, the utterance guide is not presented in the guide area 212 by the display device 109, and a voice is presented from the speaker 110. Therefore, even a user who is doing two things at one time can recognize the content of the utterance guide.

Furthermore, in outputting an utterance guide with a voice, the voice interaction system 1 desirably presents an utterance guide with a delimited short utterance instead of one breath of utterance, for example, so that the target user can remember the content. Meanwhile, if the user is in a situation of hurry, it is desirable to present an utterance guide that can be said in one breath.

Furthermore, a scene where some users speak in a divided manner instead of in one breath is assumed in making an utterance. In such a scene, the voice interaction system 1 presents an utterance guide of an utterance that can be said in a divided manner instead of in one breath, in accordance with a user who has a tendency (habit) to split.

For example, in a case of registering a schedule by a voice interaction, an utterance guide that can be said in a divided manner is presented to a user who speaks in a divided manner such as “Add school trip to calendar” and “Date is October 13 to 16”. Meanwhile, for example, an utterance guide that can be uttered as short as possible may be presented to a user who is presented with an utterance guide that can be said in one breath, and who can immediately say it.

Furthermore, for example, an utterance guide of a shortened utterance that can be said in one breath may be presented to a user who makes no utterance for a while after uttering “Add schedule of school trip” and makes no additional utterance until asked back missing items from the system and the missing items may be asked back.

Here, a scene in which the third interaction is performed, as described below, is assumed as an interaction between the user and the system.

(Example of Third Interaction)

S: “You can say “Play song of XXX band””

U: “Play song of YYY band”

S: “Which song would you like?”

U: “Anything is fine”

S: “I will play the album ZZZ”

In the third interaction example, the voice interaction system 1 has output the utterance guide of “You can say “Play song of XXX band”” with a voice on the basis of the utterance tendency of the user and has received the user utterance of “Play song of YYY band”, but the information is insufficient for implementing a music play function. Therefore, the voice interaction system 1 can acquire information regarding a song to be played by asking (asking back) a question of “Which song would you like?” to the user.

Furthermore, in presenting an utterance guide, the voice interaction system 1 can perform presentation so that the user can say only minimum required essential items. That is, here, the guide is separately performed for the essential items and the other items.

For example, an utterance guide of “You can enter start time” can be presented as the essential item for an utterance guide of “You can register schedule by saying “Add schedule of soccer game on October 20”. Furthermore, for example, an utterance guide of “You can specify location” can be presented as the essential item for an utterance guide of “Weather near home will be displayed if you say “Tell me tomorrow's weather”.

Furthermore, items that can be taken over in an interaction between the user and the system can be presented as an utterance guide. Here, a scene in which the fourth interaction is performed, as described below, is assumed as an interaction between the user and the system.

(Example of Fourth Interaction)

U: “Where is this event going?”

S: “It's in Yokohama”

S: “You will get weather in Yokohama if you ask “Weather now?””

In the fourth interaction example, the voice interaction system 1 has made a response of “It's in Yokohama” on the basis of the user utterance of “Where is this event going?”. From the content of the interaction, “event” and “Yokohama” can be extracted as the taken over items. Then, the voice interaction system 1 presents the utterance guide of “You will get weather in Yokohama if you ask “Weather now?””, which is supposed to be useful information for the user, on the basis of the taken over items extracted from the content of the interaction.

Note that the utterance guide may be presented in the guide area 212 by the display device 109 or may be presented with a voice from the speaker 110.

(K) Eleventh Utterance Guide Control Method

In the case of using the above-described eleventh utterance guide control method (K), an utterance guide is presented according to the way of use of an application by the user.

For example, in a case where the target user has not mastered functions of a target application and has mastered another application, the voice interaction system 1 presents an utterance guide of another function of the target application on the basis of the user information.

Furthermore, for example, in a case where the target user has mastered the functions of the target application, or in a case where the target user has not mastered the another application, the voice interaction system 1 presents an utterance guide of the another application.

Note that, as a definition as to whether the target user has mastered functions of an application, various definitions can be adopted but, for example, the target user can be regarded to have mastered functions of a target application in a case where the target user has been using various functions from among a plurality of functions included in the application (in a case where the number of functions being used by the target user is large).

As described above, in the eleventh utterance guide control method, in a case where the user is determined not to be proficient in the application, for example, according to the user's way of use of the application, utterance guides in a variety of directions are presented to the user to experience the application wide and shallow.

(L) Others

Note that the above-described utterance guide control methods (A) to (K) are merely examples, and other utterance guide control methods may be used. For example, the following utterance guide control methods can be used.

(First Another Example)

In a case where the user has achieved some goal with another device (for example, a smartphone or the like) possessed by the user, and that is implementable by a function of the voice interaction system 1, a message of “You can do it with the agent” can be presented in the another device such as the smartphone.

Meanwhile, in a case where the voice interaction system 1 has achieved some goal and it is better to execute it with another device (for example, a smartphone or the like) possessed by the user, an utterance guide informing that execution with the another device such as the smartphone is better can be presented, for example. For example, in a case where execution with another device enables faster processing, obtainment of more detailed information, and use of a special function because of member registration, an utterance guide of such information is only required to be presented.

(Second Another Example)

For example, the local-side terminal device 10 may present an utterance guide seeming to want to say something to the user in a case where there are functions (tips) useful for the user. More specifically, the display device 109 may display a speech bubble for the agent's character presented in the main area 211 or may display the agent's character looking at the user or waiting while opening the mouth. Note that a peripheral visual field may emit light, for example, instead of the speech bubble.

As described above, the local-side terminal device 10 performs display and light emission different from usual as a mode different from the normal mode, thereby notifying the user that there are useful functions (tips). Then, in a case where the user sees a target area (e.g., display or light emission area) or makes an utterance (e.g., a question, a presentation instruction, or the like) in response to the notification, the voice interaction system 1 can present the useful functions (tips) in the guide area 212 by the display device 109, for example.

(Third Another Example)

Furthermore, the voice interaction system 1 may record a use rate (utterance guide use rate) as to what extent the user actually utters the content of the utterance guides presented in the guide area 212 as the user information (for example, use history information), using the display device 109, for example. Note that the utterance guide use rate can be recorded for each user.

Thereby, the voice interaction system 1 can present an utterance guide in the guide area 212 on the basis of the utterance guide use rate in the next and subsequent times. Here, for example, a proposal similar to the content of an actually uttered utterance guide can be presented in the guide area 212.

(Fourth Another Example)

Furthermore, in a case where the voice interaction system 1 erroneously recognizes the user's intention as a result of semantic analysis for the user's utterance, related useful functions (tips) or functional proposals may be presented in the guide area 212 as utterance guides. Here, as a case of erroneously recognizing the user's intention, for example, restatement, returning, canceling, or the like after a request utterance by the user is assumed, and presenting information (useful information) related thereto as an utterance guide can draw the attention of the user.

As described above, the voice interaction system 1 executes the utterance guide control processing, thereby presenting a more appropriate utterance guide to the user.

In particular, in a case of using a voice user interface, a situation where way of saying is difficult for the user tends to occur, and such a situation varies depending on the function or the user, so support is difficult. However, the voice interaction system 1 to which the present technology is applied can easily support such a situation.

That is, the voice interaction system 1 dynamically changes (switches) the utterance guide to be presented, using not only the functions used by the user and the state of the application but also, for example, the way of saying by the user and the use history (including the proficiency level) of the functions so far. Therefore, a more appropriate utterance guide can be presented to the user.

Note that the number of users who use the same terminal device 10 is not limited to one, and a plurality of users is assumed, for example, in a case of using the terminal device 10 by a family. In such a case, the utterance guide can be presented not only in the terminal device 10 but also in other devices (smartphones or the like possessed by the users, for example). Furthermore, in such a case, the utterance guide is also presented in different modals (for example, the image display by the display device 110, the voice output by the speaker 111, and the like) in addition to being presented in the other devices.

(Flow of Guide Presentation Processing)

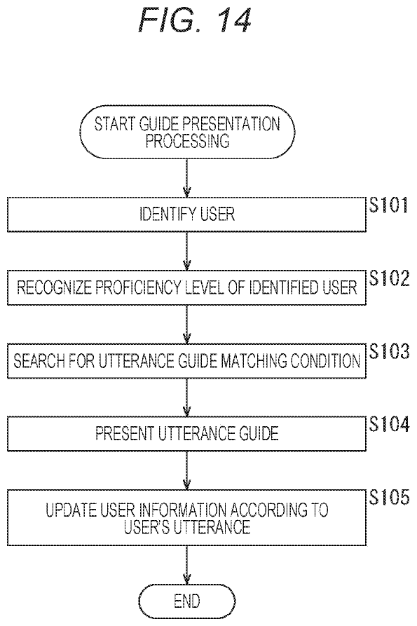

Next, a flow of guide presentation processing executed by the voice interaction system 1 will be described with reference to the flowchart in FIG. 14.

In step S101, the user recognition unit 103 executes the user recognition processing on the basis of the image data from the camera 101 to recognize the target user.

In step S102, the user state estimation unit 106 checks the proficiency level of the identified target user by appropriately referring to the user information recorded in the user DB 131 on the basis of the information such as the result of user recognition obtained in the processing in step S101.

In step S103, the utterance guide control unit 107 searches for an utterance guide matching a condition by appropriately referring to the utterance guide information recorded in the utterance guide DB 132 on the basis of the proficiency level of the target user obtained in the processing in step S102. Here, for example, an utterance guide corresponding to the proficiency level of the system of the target user is obtained.

In step S104, the presentation method control unit 108 presents the utterance guide obtained in the processing in step S103 under the control of the utterance guide control unit 107. Here, for example, the display device 109 presents the utterance guide in the guide area 212 in the display area 201.

When the processing in step S104 ends, the processing proceeds to step S105. In step S105, the user state estimation unit 106 updates target user information recorded in the user DB 131 according to an utterance of the user.

Here, for example, in a case where an utterance according to the content of the utterance guide is made by the user who has checked the utterance guide presented in the guide area 212, information indicating the fact of the utterance is registered as the target user information. When the processing in step 5105 ends, the guide presentation processing ends.

A flow of the guide presentation processing has been described.

(Flow of Guide Presentation Processing According to User State)

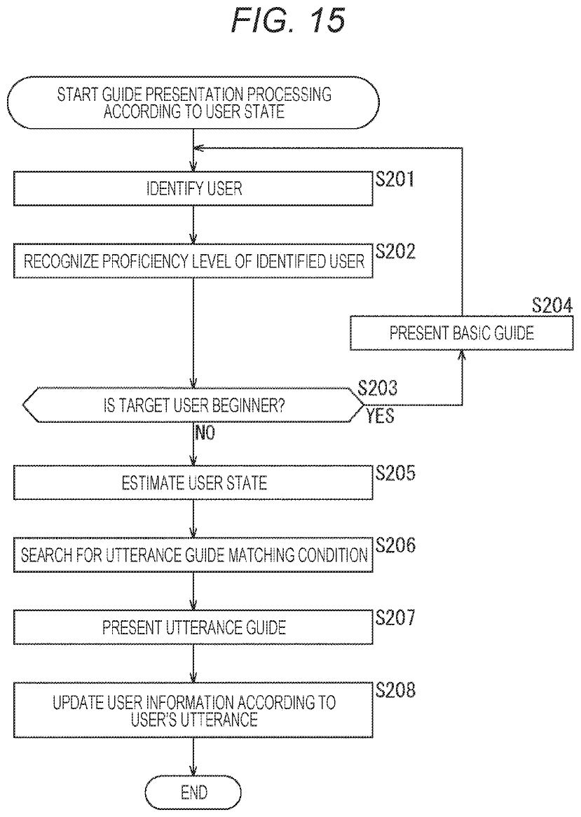

Next, a flow of the guide presentation processing according to a user state will be described with reference to the flowchart in FIG. 15. Note that the guide presentation processing according to a user state corresponds to the above-described fourth utterance guide control method.

In steps S201 and S202, the user recognition processing is executed, and the proficiency level of the identified target user is checked, similarly to steps S101 and S102 in FIG. 14 above.

In step S203, the user state estimation unit 106 determines whether or not the target user is a beginner on the basis of the proficiency level of the target user obtained in the processing in step S202. Note that, here, whether or not the target user is a beginner is determined by comparing a threshold value for determining a predetermined proficiency level and a value indicating the proficiency level of the target user.

In step S203, in a case of determining that the target user is a beginner (in a case where the value indicating the proficiency level is lower than the threshold value), the processing proceeds to step S204. In step S204, the presentation method control unit 108 presents the basic guide under the control of the utterance guide control unit 107. Here, for example, the display device 109 presents the basic guide regarding more basic functions in the guide area 212 in the display area 201.

When the processing in step S204 ends, the processing returns to step S201 and the processing in step S201 and subsequent steps is repeated. Then, in step S203, in a case of determining that the target user is not a beginner (in a case where the value indicating the proficiency level is higher than the threshold value), the processing proceeds to step S205.

In step S205, the user state estimation unit 106 executes the user state estimation processing to estimate the state of the target user. In the user state estimation processing, for example, the state of the target user is estimated on the basis of information such as a habit, the degree of relaxation, the degree of urgency, or a current location of the target user

In step S206, the utterance guide control unit 107 searches for an utterance guide matching a condition by appropriately referring to the utterance guide information recorded in the utterance guide DB 132 on the basis of the result of user state estimation obtained in the processing in step S205. Here, for example, the application guide corresponding to the proficiency level of the system of the target user is obtained.

In step S207, the presentation method control unit 108 presents the utterance guide obtained in the processing in step S206 under the control of the utterance guide control unit 107. Here, for example, the application guide is presented in the guide area 212 by the display device 109.

In step S208, the target user information is updated according to the utterance of the user, similarly to step S105 in FIG. 14 above. When the processing in step S208 ends, the guide presentation processing according to the user state ends.

A flow of the guide presentation processing according to a user state has been described.

(Flow of Guide Presentation Processing According to Way of Use)

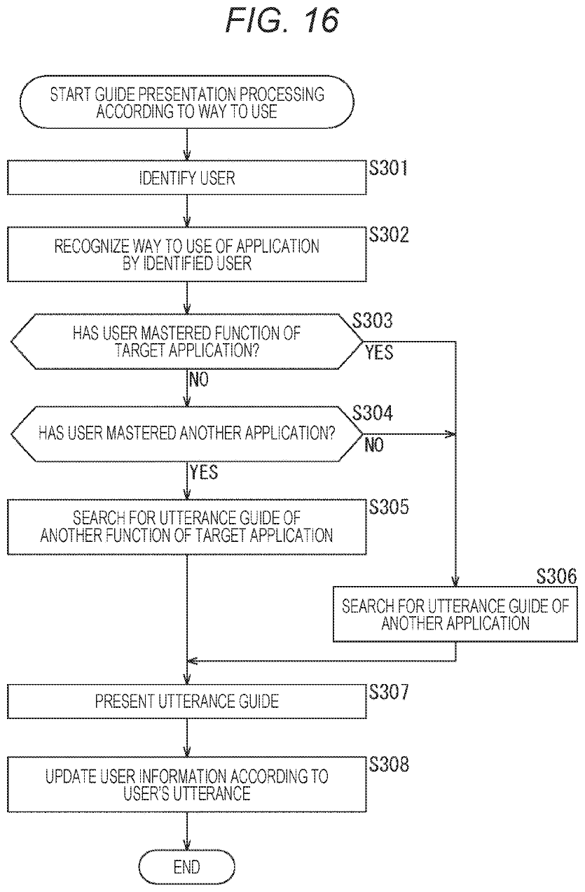

Next, a flow of the guide presentation processing according to way of use will be described with reference to the flowchart in FIG. 16. Note that the guide presentation processing according to way of use corresponds to the above-described eleventh utterance guide control method.

In step S301, the user recognition processing is executed, and the target user is identified, similarly to step S101 in FIG. 14 above.

In step S302, the user state estimation unit 106 checks the way of use of an application (hereinafter also referred to as app use situation) by the identified target user by appropriately referring to the user information recorded in the user DB 131 on the basis of the information such as the result of user recognition obtained in the processing in step S301.

In step S303, the user state estimation unit 106 determines whether or not the target user has mastered functions of the target application being currently used on the basis of the app use situation obtained in the processing in step S303.

Here, as the definition as to whether the target user has mastered functions of an application, the target user can be regarded to have mastered functions of a target application in a case where the target user has been using various functions from among a plurality of functions included in the target application (in a case where the number of functions being used by the target user is large).

In step S303, in a case of determining that the target user has not mastered the functions of the target application, the processing proceeds to step S304. In step S304, the user state estimation unit 106 determines whether or not the target user has mastered another application on the basis of the app use situation obtained in the processing in step S303.

In step S304, in a case of determining that the target user has mastered the another application, the processing proceeds to step S305. In step S305, the utterance guide control unit 107 searches for an utterance guide for another function of the target application by appropriately referring to the utterance guide information recorded in the utterance guide DB 132.

When the processing in step S305 ends, the processing proceeds to step S307. In step S307, the presentation method control unit 108 presents the utterance guide of another function of the target application obtained in the processing in step S305 under the control of the utterance guide control unit 107. Here, for example, the display device 109 presents the utterance guide of the another function of the target application being currently used in the guide area 212.

On the other hand, in step S303, in a case of determining that the target user has mastered the functions of the target application, or in step S304, in a case of determining that the target user has not mastered the another application, the processing proceeds to step S306.

In step S306, the utterance guide control unit 107 searches for an utterance guide for the another application by appropriately referring to the utterance guide information recorded in the utterance guide DB 132.

When the processing in step S306 ends, the processing proceeds to step S307. In step S307, the presentation method control unit 108 presents the utterance guide of another application obtained in the processing in step S306 under the control of the utterance guide control unit 107. Here, for example, the display device 109 presents the utterance guide of the another application in the guide area 212.

When the processing in step S307 ends, the processing proceeds to step S308. In step S308, the target user information is updated according to the utterance of the user, similarly to step S105 in FIG. 14 above. When the processing in step S308 ends, the guide presentation processing according to way of use ends.

A flow of the guide presentation processing according to way of use has been described.

Note that, in the guide presentation processing illustrated in FIGS. 14 to 16, the guide presentation processing corresponding to the above-described fourth utterance guide control method and eleventh utterance guide control method has been particularly described. However, the utterance guide presented by the display device 109 or the speaker 110 can be controlled on the basis of one control method or a combination of a plurality of control methods, of the utterance guide control methods (A) to (L), as described above.

(Specific Example of Utterance Guide Presentation)

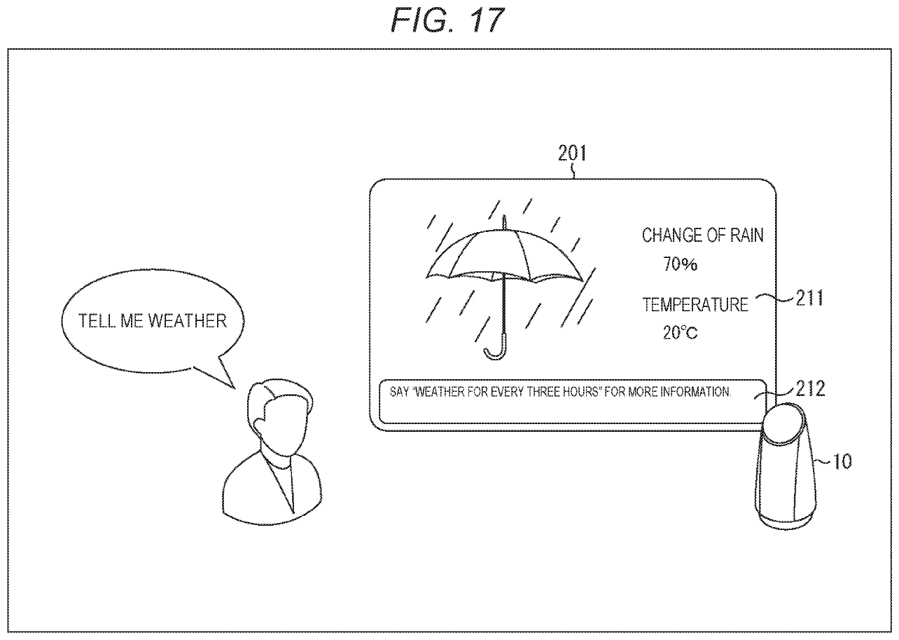

FIG. 17 is a diagram illustrating a specific example of presentation of an utterance guide at the time of an interaction between a user and a system.

In FIG. 17, in a case where the user has uttered “Tell me the weather”, the voice interaction system 1 acquires information of today's weather forecast because the intention of the user utterance is “weather check”, and presents the information in the main area 211 in the display area 201. Furthermore, at this time, an utterance guide of “Tell me “weather for every three hours” for more information”. in the guide area 212.

Therefore, the user checks the utterance guide presented in the guide area 212, and utters “weather for every three hours” to the system when the user wants to know more specific information about the weather. Then, in a case where the user has uttered “weather for every three hours”, the voice interaction system 1 executes a function to present information of weather forecast for every three hours of a target region as the today's weather forecast, and presents a result of the execution in the main area 211.

<2. Modification>

In the above-described description, in the voice interaction system 1, a configuration in which the camera 101, the microphone 102, the display device 109, and the speaker 110 are incorporated in the local-side terminal device 10, and the user recognition unit 103 to the presentation method control unit 108 are incorporated in the cloud-side server 20 has been described as an example. However, each of the camera 101 to the speaker 110 may be incorporated in either the terminal device 10 or the server 20.

For example, all of the camera 101 to the speaker 110 may be incorporated in the terminal device 10 side, and the processing may be completed on the local side. Note that, even in the case of adopting such a configuration, the databases such as the user DB 131 and the utterance guide DB 132 can be managed by the server 20 on the Internet 30.

Furthermore, for the voice recognition processing performed by the voice recognition unit 104 and the semantic analysis processing performed by the semantic analysis unit 105, a voice recognition service and a semantic analysis service provided by other services may be used. In this case, the server 20 can obtain a result of voice recognition by sending voice data to the voice recognition service provided on the Internet 30, for example. Furthermore, for example, the server 20 can obtain a result (Intent and Entity) of semantic analysis by sending data (text data) of a result of voice recognition to the semantic analysis service provided on the Internet 30.

Note that the above description has been made such that the intention (Intent) and the entity information (Entity) are obtained as a result of semantic analysis in the semantic analysis processing. However, that is an example, and another piece of information may be used as long as the information expresses a meaning (intention) of an utterance by the user.

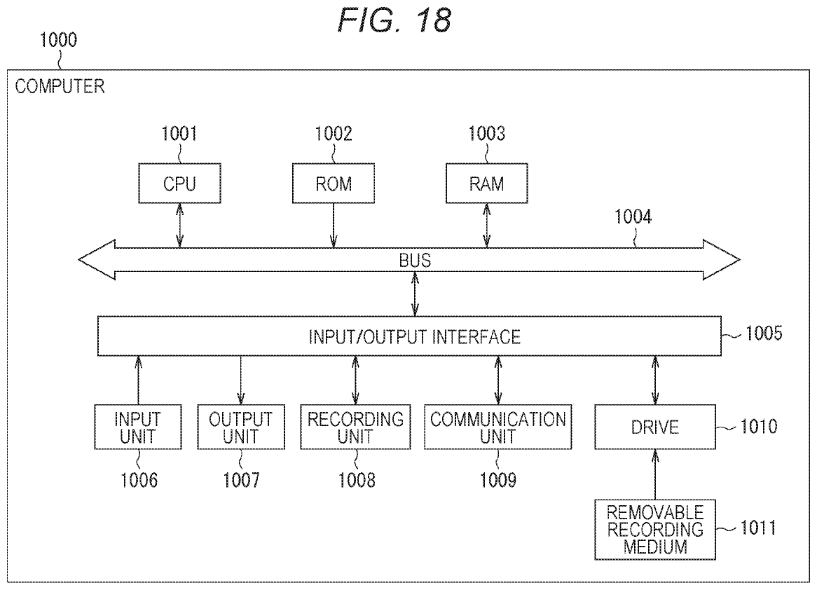

Here, the terminal device 10 and the server 20 may be configured as information processing devices including a computer 1000 in FIG. 18 to be described below.

That is, the user recognition unit 103, the voice recognition unit 104, the semantic analysis unit 105, the user state estimation unit 106, the utterance guide control unit 107, and the presentation method control unit 108 are implemented by, for example, a CPU of the terminal device 10 or the server 20 (for example, a CPU 1001 in FIG. 18 to be described below) executing a program recorded in a recording unit (for example, a ROM 1002, a recording unit 1008, or the like in FIG. 18 to be described below).

Furthermore, although not illustrated, each of the terminal device 10 and the server 20 includes a communication interface (I/F) (a communication unit 1009 in FIG. 18 to be described below, for example) configured by a communication interface circuit and the like to exchange data via the Internet 30. With the configuration, the terminal device 10 and the server 20 can perform communication via the Internet 30, and the server 20 side can perform processing such as the utterance guide control processing and the presentation method control processing on the basis of data from the terminal device 10, for example, during a user's utterance.

Moreover, in the terminal device 10, an input unit (for example, an input unit 1006 in FIG. 18 to be described below) including a button, a keyboard, and the like may be provided to obtain an operation signal according to a user's operation, or the display device 109 (for example, an output unit 1007 in FIG. 18 to be described below) may be configured as a touch panel integrated with a touch sensor to obtain an operation signal according to an operation by a user's finger or a touch pen (stylus pen).

Note that, regarding the functions of the presentation method control unit 108 illustrated in FIG. 2, some of all the functions may be provided as functions of the terminal device 10 and remaining functions may be provided as functions of the server 20, instead of all the functions being provided as the functions of the terminal device 10 or of the server 20. For example, a rendering function, of display control functions of the presentation method control, can be provided as a function of the local-side terminal device 10, and a display layout function, of the display control functions of the presentation method control, can be provided as a function of the cloud-side server 20.

Furthermore, in the voice interaction system 1 illustrated in FIG. 2, the input device such as the camera 101 or the microphone 102 is not limited to the terminal device 10 configured as a dedicated terminal or the like but also another electronic device such as a mobile device (for example, a smartphone) owned by the user. Moreover, in the voice interaction system 1 illustrated in FIG. 2, the output device such as the display device 109 or the speaker 110 may also be another electronic device such as a mobile device (for example, a smartphone) owned by the user.

Moreover, in the voice interaction system 1 illustrated in FIG. 2, a configuration including the camera 101 having the image sensor has been illustrated. However, another sensor device may be provided and perform sensing of the user and surroundings of the user to acquire sensor data according to a sensing result, and the sensor data may be used in subsequent processing.

Here, examples of the sensor device include a biological sensor that detects biological information such as a breath, a pulse, a fingerprint, and an iris, a magnetic sensor that detects the magnitude and direction of a magnetic field (magnetic field), an acceleration sensor that detects acceleration, a gyro sensor that detects an angle (posture), an angular velocity, and angular acceleration, a proximity sensor that detects an approaching object, and the like.

Furthermore, the sensor device may be an electroencephalogram sensor attached to the head of the user and measuring a potential or the like to detect an electroencephalogram. Moreover, the sensor device can include sensors for measuring a surrounding environment such as a temperature sensor that detects temperature, a humidity sensor that detects humidity, and an ambient light sensor that measures brightness of surroundings, and a sensor for detecting positional information such as a global positioning system (GPS) signal.

<3. Configuration of Computer>

The above-described series of processing (for example, the guide presentation processing illustrated in FIGS. 14 to 16) can be executed by hardware or can be executed by software. In the case of executing the series of processing by software, a program that configures the software is installed in a computer of each device. FIG. 18 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected by a bus 1004. Moreover, an input/output interface 1005 is connected to the bus 1004. An input unit 1006, an output unit 1007, a recording unit 1008, a communication unit 1009, and a drive 1010 are connected to the input/output interface 1005.

The input unit 1006 includes a microphone, a keyboard, a mouse, and the like. The output unit 1007 includes a speaker, a display, and the like. The recording unit 1008 includes a hard disk, a nonvolatile memory, and the like. The communication unit 1009 includes a network interface and the like. The drive 1010 drives a removable recording medium 1011 such as a magnetic disk, an optical disk, a magneto-optical disk, or a semiconductor memory.

In the computer 1000 configured as described above, the CPU 1001 loads the program recorded in the ROM 1002 or the recording unit 1008 to the RAM 1003 via the input/output interface 1005 and the bus 1004 and executes the program, so that the above-described series of processing is performed.

The program to be executed by the computer 1000 (CPU 1001) can be recorded on the removable recording medium 1011 as a package medium or the like, for example, and can be provided. Furthermore, the program can be provided via a wired or wireless transmission medium such as a local area network, the Internet, or digital satellite broadcasting.

In the computer 1000, the program can be installed to the recording unit 1008 via the input/output interface 1005 by attaching the removable recording medium 1011 to the drive 1010. Furthermore, the program can be received by the communication unit 1009 via a wired or wireless transmission medium and installed in the recording unit 1008. Other than the above method, the program can be installed in the ROM 1002 or the recording unit 1008 in advance.

Here, in the present specification, the processing performed by the computer in accordance with the program does not necessarily have to be performed in chronological order in accordance with the order described as the flowchart. In other words, the processing performed by the computer according to the program also includes processing executed in parallel or individually (for example, parallel processing or processing by an object). Furthermore, the program may be processed by one computer (processor) or distributed in and processed by a plurality of computers.

Note that embodiments of the present technology are not limited to the above-described embodiments, and various modifications can be made without departing from the gist of the present technology.

Furthermore, the steps of the guide presentation processing illustrated in FIGS. 14 to 16 can be executed by one device or can be shared and executed by a plurality of devices. Furthermore, in the case where a plurality of processes is included in one step, the plurality of processes included in the one step can be executed by one device or can be shared and executed by a plurality of devices.

Note that the present technology can employ the following configurations.

(1)

An information processing device including:

a first control unit configured to control presentation of an utterance guide suitable for a user who makes an utterance on the basis of user information regarding the user.

(2)

The information processing device according to (1), in which

the first control unit controls the utterance guide according to a state or a situation of the user.

(3)

The information processing device according to (2), in which

the state or the situation of the user includes at least a habit or an utterance tendency at a time of the utterance of the user, an index representing an emotion at the time of the utterance of the user, or information regarding a location of the user.

(4)

The information processing device according to (1), in which

the first control unit controls the utterance guide according to a taste or a behavioral tendency of the user.

(5)

The information processing device according to (4), in which

the first control unit performs control to preferentially present the utterance guide regarding an area of interest of the user.

(6)

The information processing device according to (1), in which

the first control unit controls the utterance guide according to a proficiency level or a use method of the user.

(7)

The information processing device according to (6), in which

the first control unit performs control such that

the utterance guide regarding a basic function is presented in a case where a value indicating the proficiency level of the user is lower than a threshold value, and

the utterance guide regarding an advanced function is presented in a case where the value indicating the proficiency level of the user is higher than the threshold value.

(8)

The information processing device according to (6), in which

the first control unit performs control such that the utterance guide regarding another function of a target application or the utterance guide regarding another application is presented according to way of use of a function of an application by the user.

(9)

The information processing device according to (1), in which

the first control unit performs control such that the presentation of the utterance guide is able to be sequentially switched for each possibility of suitability to the user, each priority, or each target function.

(10)

The information processing device according to any one of (1) to (9), in which

the first control unit controls the utterance guide including a proposal of a function to the user.

(11)

The information processing device according to any one of (1) to (10), in which

the first control unit controls the utterance guide on the basis of a result of semantic analysis for the utterance of the user and a result of user recognition for image data obtained by imaging the user.

(12)

The information processing device according to any one of (1) to (11), further including:

a second control unit configured to present the utterance guide in at least one presentation unit of a first presentation unit or a second presentation unit.

(13)

The information processing device according to (12), in which

the first presentation unit is a display device,

the second presentation unit is a speaker, and

the second control unit displays the utterance guide in a guide area including a predetermined area in a display area of the display device.

(14)

The information processing device according to (12), in which

the first presentation unit is a display device,

the second presentation unit is a speaker, and

in a case where the user is performing a task other than a voice interaction, the second control unit outputs a voice of the utterance guide from the speaker.

(15)

An information processing method of an information processing device, including:

by the information processing device,

controlling presentation of an utterance guide suitable for a user who makes an utterance on the basis of user information regarding the user.

(16)

An information processing device including:

a first control unit capable of implementing a same function as a function according to a first utterance in a case where the first utterance is made by a user, and configured to control presentation of an utterance guide for proposing a second utterance shorter than the first utterance.

(17)

The information processing device according to (16), in which

the first control unit controls the utterance guide on the basis of user information regarding the user who makes an utterance.

(18)

The information processing device according to (17), in which

the first control unit presents the utterance guide according to a proficiency level of the user.

(19)

The information processing device according to any one of (16) to (18), further including:

a second control unit configured to display the utterance guide in a guide area including a predetermined area in a display area of a display device.

(20)

An information processing method of an information processing device, including:

by the information processing device that is capable of implementing a same function as a function according to a first utterance in a case where the first utterance is made by a user,

controlling presentation of an utterance guide for proposing a second utterance shorter than the first utterance.

### REFERENCE SIGNS LIST

1 Voice interaction system
10 Terminal device
20 Server
30 Internet
101 Camera
102 Microphone
103 User recognition unit
104 Voice recognition unit
105 Semantic analysis unit
106 User state estimation unit
107 Utterance guide control unit
108 Presentation method control unit
109 Display device
110 Speaker
131 User DB
132 Utterance guide DB
1000 Computer
1001 CPU

1. An information processing device comprising:
a first control unit configured to control presentation of an utterance guide suitable for a user who makes an utterance on a basis of user information regarding the user.

2. The information processing device according to claim 1, wherein
the first control unit controls the utterance guide according to a state or a situation of the user.

3. The information processing device according to claim 2, wherein
the state or the situation of the user includes at least a habit or an utterance tendency at a time of the utterance of the user, an index representing an emotion at the time of the utterance of the user, or information regarding a location of the user.

4. The information processing device according to claim 1, wherein
the first control unit controls the utterance guide according to a taste or a behavioral tendency of the user.

5. The information processing device according to claim 4, wherein
the first control unit performs control to preferentially present the utterance guide regarding an area of interest of the user.

6. The information processing device according to claim 1, wherein
the first control unit controls the utterance guide according to a proficiency level or a use method of the user.

7. The information processing device according to claim 6, wherein
the first control unit performs control such that
the utterance guide regarding a basic function is presented in a case where a value indicating the proficiency level of the user is lower than a threshold value, and
the utterance guide regarding an advanced function is presented in a case where the value indicating the proficiency level of the user is higher than the threshold value.

8. The information processing device according to claim 6, wherein
the first control unit performs control such that the utterance guide regarding another function of a target application or the utterance guide regarding another application is presented according to way of use of a function of an application by the user.

9. The information processing device according to claim 1, wherein
the first control unit performs control such that the presentation of the utterance guide is able to be sequentially switched for each possibility of suitability to the user, each priority, or each target function.

10. The information processing device according to claim 1, wherein
the first control unit controls the utterance guide including a proposal of a function to the user.

11. The information processing device according to claim 1, wherein
the first control unit controls the utterance guide on a basis of a result of semantic analysis for the utterance of the user and a result of user recognition for image data obtained by imaging the user.

12. The information processing device according to claim 1, further comprising:
a second control unit configured to present the utterance guide in at least one presentation unit of a first presentation unit or a second presentation unit.

13. The information processing device according to claim 12, wherein
the first presentation unit is a display device,
the second presentation unit is a speaker, and
the second control unit displays the utterance guide in a guide area including a predetermined area in a display area of the display device.

14. The information processing device according to claim 12, wherein
the first presentation unit is a display device,
the second presentation unit is a speaker, and
in a case where the user is performing a task other than a voice interaction, the second control unit outputs a voice of the utterance guide from the speaker.

15. An information processing method of an information processing device, comprising:
by the information processing device,
controlling presentation of an utterance guide suitable for a user who makes an utterance on a basis of user information regarding the user.

16. An information processing device comprising:
a first control unit capable of implementing a same function as a function according to a first utterance in a case where the first utterance is made by a user, and configured to control presentation of an utterance guide for proposing a second utterance shorter than the first utterance.

17. The information processing device according to claim 16, wherein
the first control unit controls the utterance guide on a basis of user information regarding the user who makes an utterance.

18. The information processing device according to claim 17, wherein
the first control unit presents the utterance guide according to a proficiency level of the user.

19. The information processing device according to claim 16, further comprising:
a second control unit configured to display the utterance guide in a guide area including a predetermined area in a display area of a display device.

20. An information processing method of an information processing device, comprising:
by the information processing device that is
capable of implementing a same function as a function according to a first utterance in a case where the first utterance is made by a user,
controlling presentation of an utterance guide for proposing a second utterance shorter than the first utterance.
